(19) United States
(12) Patent Application Publication
(10) Pub. No.: US 2002/0143688 A1
(43) Pub. Date: Oct. 3, 2002

(54) Network system for coordinating proposals relating to the provision of services such as restaurants services for event planners

(76) Inventors: Gregory Truitt, Philadelphia, PA (US); Timothy Stephens, Philadelphia, PA (US); Kevin Baird, Philadelphia, PA (US)

Correspondence Address: OBERMAYER REBMANN MAXWELL & HIPPEL LLP, 1617 JOHN F KENNEDY BLVD, 19TH FLOOR, PHILIDELPHIA, PA, 19103, US

(21) Appl. No.: 09/823,302

(22) Filed: Mar. 30, 2001

(51) Int. Cl. G06F 17/60; G06F 15/16

(52) U.S. Cl. 705/37; 709/203

(57) ABSTRACT

An apparatus for managing communications between an event planner and a venue such as a restaurant comprising a control unit for receiving a event request generated by a prospective event planner, relating to a desire for planning an event; means for assisting a client in formulating a request for proposal to be distributed to event venues throughout the system; means for distributing the request for proposal to said event venues; and means for receiving bids from venues who receive the request for proposal.

### FIELD OF THE INVENTION

The present invention is directed to online computer systems. In particular, the present invention is specifically directed to online computer systems which can be used to schedule events for restaurants, caterers, event planners and the like.

### BACKGROUND OF THE INVENTION

The Internet or World Wide Web is one of the most critical technological developments of the 1990's. The Internet has provided vast economic opportunities for numerous businesses and industries to vastly expand the number and quality of their services. One of the earliest and fastest emerging areas of Internet activity has been in providing rapid, up-to-the-minute business information. To date, a number of patents have issued on Internet related systems which cover a wide array of business information and electronic commerce (e-commerce) applications.

Heretofore, the Internet has been applied to auctioning of a large number of area applications. U.S. Pat. No. 5,835,896 discloses a system and method for conducting a multi-person interactive ad auction in a variety of formats without using a human auctioneer to conduct the auction. This system is preferably implemented in software and allows a group of bidders to interactively place bids over computer and communications network. Those bids are recorded by the system and bidders are updated with current auction status information. When appropriate, the system closes the auction from further bidding and notifies the winning bidders and losers as to the auction outcome.

Electronic auctions held over the Internet using electronic mail (e-mail) have also gained wide popularity. A recent innovation applied to e-mail auctions is the use of the Internet to post descriptions of the merchandise and to show the current high bids. Security brokerage firms for years have used automated transaction systems for matching buy and sell orders for securities. For example, the New York Stock Exchange's DOTS (Direct Order Transmission System) and NASDAQ SOES (Small Order Execution System) systems offer complete electronic matching of buyers and sellers.

A number of U.S. patents have issued related to various forms of electronic commerce. These patents fall into three broad categories: (1) patents relating to online networks; (2) patents relating to electronic commerce over on-line networks; and (3) patents relating to various forms of securities trading via electronic means. U.S. Pat. No. 5,406,475 entitled “Data Processing Network Having a Plurality of Independent Subscribers”, U.S. Pat. No. 5,235,680 entitled “Apparatus and Method for Communicating Textural and Image Information between a Host Computer and a Remote Display Terminal”, and U.S. Pat. No. 5,310,997 entitled “Automated Order and Delivery System” are representative of the prior art.

A second group of patents relating to electronic commerce, U.S. Pat. No. 5,285,383 entitled “Method for Carrying Out Transactions Using Electronic Title” and U.S. Pat. No. 5,297,031 entitled “Method and Apparatus for Order Management and Market Brokers,” describe various means for conducting transactions over electronic communications networks. U.S. Pat. No. 4,789,928 discloses a means for soliciting bids over an electronic network from bidders who are remote to the site of a live auction.

While there have been a number of electronic Internet auction systems, none have been applied to the particular problems of event and meeting planners. In 1999, meeting and event planners spent approximately $18.8 billion on to called dining rounds. Pharmaceutical client entertainment totaled $1.2 billion and a conservative estimate of lobbyist entertainment totaled $170 million. Heretofore, there has been a dearth of effective and efficient systems for facilitating the scheduling of meetings and the like. Frequently, meeting planners have to undertake an extensive and time consuming search to find a location and to schedule a booking. Because of the difficulty and consumption of time, meeting planners could use a system which would assist them in planning events.

Such a system would be desirable to provide a system by which event planners could schedule and book events. It is therefore an object of the present invention to provide a system, accessible via a computer network, for providing means to access restaurant and venue which can be used to schedule an event.

It is another object of the present invention to provide a networked computer system whereby information regarding RFPs (Requests For Proposal) and associated responses can be instantaneously accessed regarding the scheduling of meeting events.

It is a further object of the present invention to provide a system in which users subscribers access the system via the Internet or World Wide Web and be provided with a user interface which assists them in formulating requests for proposal regarding events.

These and other objects of the present invention and features of the present invention will become apparent from the detailed description and from the following summary, detailed description and claims.

### SUMMARY OF THE INVENTION

In one embodiment, the present invention comprises a system for arranging between a planner and a venue and a control unit for receiving a planner request generated by a prospective planner relating to a desire for restaurant services or event; means for assisting a planner in formulating a request for proposal to be distributed to users throughout the system, means for distributing the request for proposal to said venues, and means for receiving responses from venues who receive the request for proposal.

In yet another embodiment, the present invention comprises a matching apparatus for managing communications between prospective event planners and a restaurant. In particular, the invention comprises a control unit for receiving a request from a prospective planner relating to restaurant services, means for assisting the prospective planner in formulating a request for proposal to be formatted and distributed throughout a network, means for distributing the request for proposal throughout a network, means for restaurants in the network to respond to the request for proposal with a bid, and means for the prospective planner to request additional information from the restaurant to accept the bid.

In a further embodiment of the present invention, a method for electronically managing communications between a restaurant or venue having particular criteria and an end user seeking a restaurant or venue, comprising the steps of providing a control unit having a database for storing therein a plurality of venues, each venue's e-mail address corresponding to the venue, providing an interface to an end user to the system to formulate a request for proposal in conjunction with a request for restaurant service, sending out the request for proposal to a plurality of restaurant venues who may respond to the request for proposal.

### BRIEF DESCRIPTION OF THE FIGURES

FIG. 1 is a block diagram of the electronic commerce enable employee uniform purchase system in accordance with the present invention

FIG. 2 is a block diagram of the end user and server systems in accordance with the present invention.

FIG. 3 illustrates the database architecture of the present invention.

FIGS. 4 to 13 illustrate a series of input screens for use in conjunction with a the request for proposal generation system in accordance with the present invention.

### DETAILED DESCRIPTION OF THE PREFERRED EMBODIMENT

The present invention is directed to a system for placing requests for providing a system for pricing and scheduling events over a communication network using, for example, personal computers. In a most preferred embodiment, the present invention is directed to a system for placing requests for proposal and bids relating to events. For the purpose of this application, events refers to any scheduled action such as a restaurant setting, party, or related event. Planner refers to any individual or entity planning or desiring to plan an event. Venue refers to a restaurant, club and the like.

Over the past fifteen (15) years, personal computers have become relatively powerful and inexpensive and have gained widespread use in a significant number of homes and businesses. With a modem, personal computers can communicate with other computers through communication networks and access many resources on the so-called “Information Super Highway.” Companies such as America Online, CompuServe, and Prodigy, which traditionally provided so-called “content” over proprietary networks, have begun to provide access by personal computer users to an expansive international network of computer networks known as the Internet.

As is well known by those skilled in the art, the World Wide Web is a graphical sub-network of the Internet. With common “Web Browser” software such as Mosaic, Netscape Navigator, or Microsoft Explorer, end users may easily access Internet information and services on the World Wide Web. A web browser handles the functions of locating and targeting information on the Internet and displaying the information provided by the Web Server. The World Wide Web utilizes technology called “HyperText” to organize, search and present information on the Internet. Using a web browser, the end user can select a word (“Hyper-Text word”) from a view document and be linked to another document featuring information related to the word.

The present invention is broadly directed to a computer network for distributing information regarding requests for proposal from prospective planners, in a most preferred embodiment, event planners, and responses from restaurants in general. The present invention is designed, in one embodiment, to be utilized on the World Wide Web or Internet, although the present invention is equally applicable to other network environments including wireless environments including wireless environments.

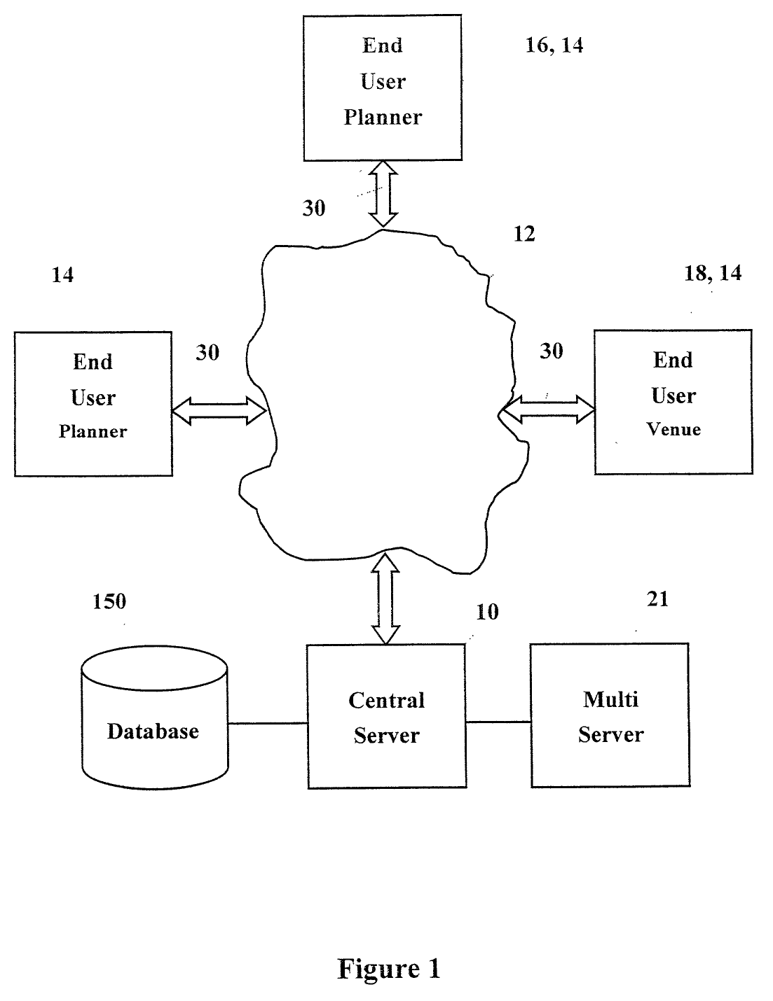

Referring to FIG. 1, a most preferred embodiment of the present invention is disclosed and shown. The most preferred embodiment comprises a central computer server 10 connected by a computer network 12 to remote end user stations 14. The central server connects to a database 150. In a preferred embodiment, end user stations 14 comprise a plurality of end user planners 16, preferable event planners 16 and a plurality of venues 18 linked via a transport medium 30.

End user planners 16 which may be event planners and event venues 18 such as clubs and restaurants, as noted above, in a most preferred embodiment, will be linked via a global computer network 12 such as the Internet or Worldwide web, but other embodiments including LANs, WANs and Intranets, fulfill the spirit and scope of the present invention. Both the event planners and event venue devices 16, 18 will typically comprise any device that connects to the system via the Internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the world wide web, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

Referring again to FIG. 1, the present invention may comprise a multi-server 21 environment which comprises a computer system in accordance with the present invention that allows the multiple users 16, 18 to communicate with one another via the system and system clients. Through communication link and transport medium 30, planner event planners 16 will schedule event itineraries with venues 18 who are linked to the central server 12, preferably by a customizable interface to be described in greater detail below.

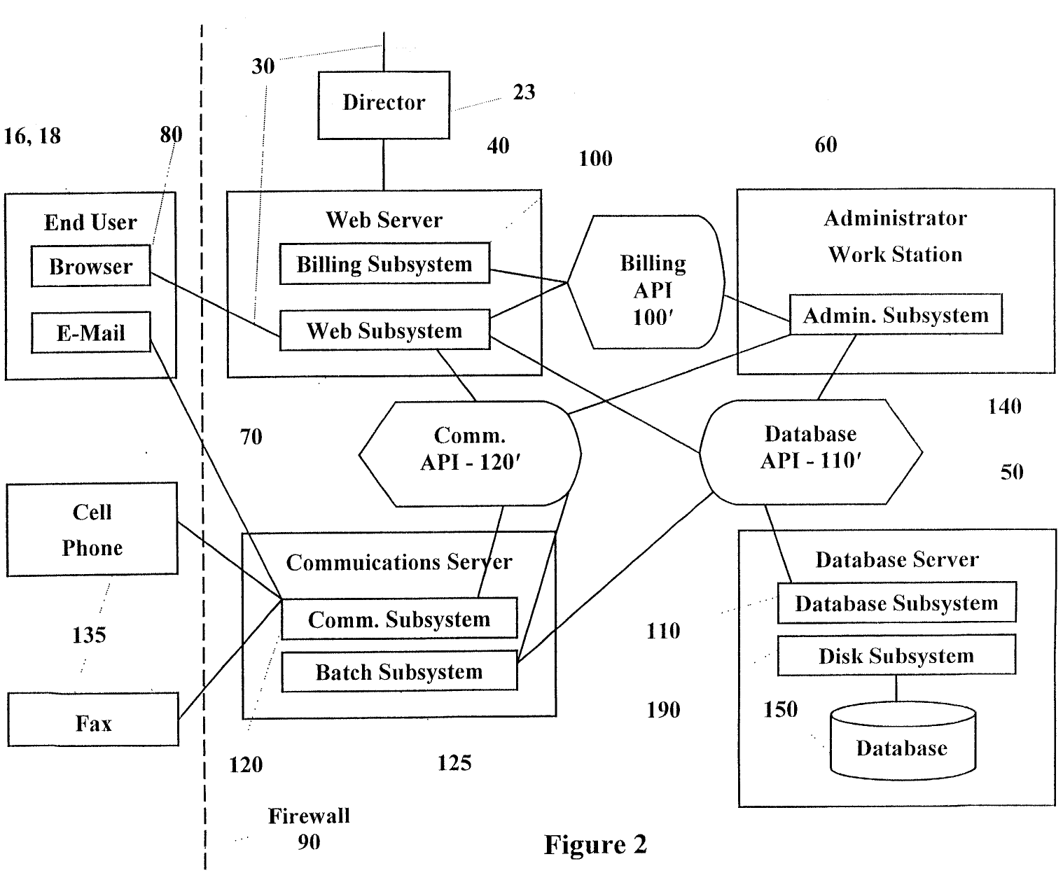

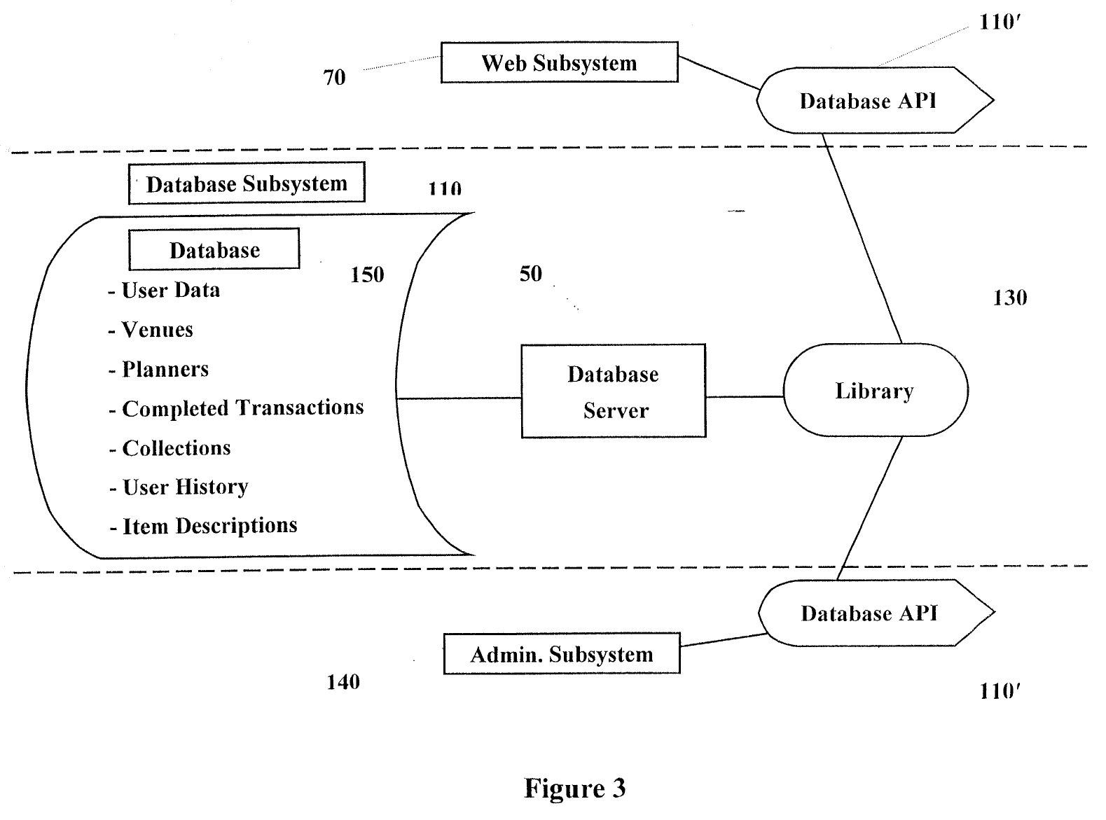

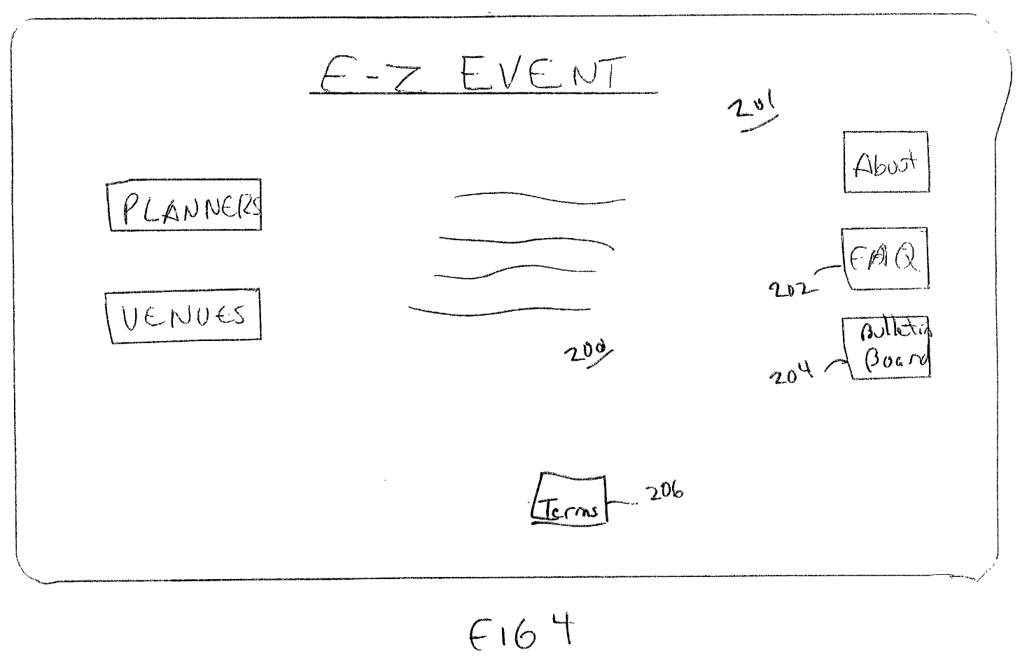

Referring to FIGS. 2 and 3, the central server and database systems of the present invention are now shown and described in greater detail. A local director 23 routes signals through the system to the various servers, to be described below, and to and through transport medium 30 to end users 16, 18. The system preferably includes two primary servers, a web server 40 and a database server 50 which may operate using such database platforms as SQL server or Oracle. Hence, in one embodiment the SQL server may run SQL server database management software from Microsoft Corporation. Alternatively, the server can further comprise an Oracle database server.

The system further includes an administrative work station 60 or system which provides the administrative capabilities and monitoring for the system under the control of an administrative subsystem 140. The administrative work station 60 allows administrators or other operators to perform routine operations which affect the entire system. Such operations include, but are not limited to, administering the accounts of both venues 18 and planners 16, creating end user templates, adding credit card, debit card or checking account information for both planners and venues, the tabulation of user balances, the printing of reports, the updating of end user and needs, the performing of backups, maintaining the programs that comprise the overall system, and managing a plurality of business software applications to be accessible to venues 18 and planners 16.

A web subsystem 70 is responsible for all interactions with a web browser 80 in the end user devices 16, 18 and serves as the end user interface to the system. All interactions between the end user devices 16, 18 and the database subsystem occur through the web subsystem 70. Internet Information Server 200 (IIS) by Microsoft Corporation is an exemplary web server software system 70 in accordance with the present invention, although the present invention is in no way limited to this system. The expression of the user interface presented to end users 16, 18 in their client devices may be implemented as HTML or other high level computer language or technology, and may be displayed in a standard web browser.

All systems listed above are preferably communicated via an Ethernet 100 base T network and a switching hub. In addition, a second isolated network segment will preferably exist between the web server 40 and the external communications hardware (e.g. internet router). Such a system will keep external traffic isolated from the internal network, as well as providing a dedicated connection between the web server 40 and the Internet for maximum throughput. The systems will have an initial configuration of random access memory for the web server 40 and preferably at least 128 megabits for the database server 50, both having the capability to expand.

The web server 40 is the point of entry to the entire system. The system determines the identity of the users 16, 18 and makes appropriate decisions while serving webpages to the users 16, 18. The web server 40 sends HTML or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-plafform operating system provided by Microsoft Corporation. The Sun Microsystems Solaris is an alternative embodiment. The server typically includes IIS, which is a completely integrated Internet application platform. IIS includes a high-performance web server, an application development environment, integrated full-text searching, multi-media streaming and site management tools. The security infrastructure is integrated within the server, thus enabling an easy-to-maintain and highly-secure web development and deployment environment.

The operators of the system may create, delete and update account information by utilizing the administrative subsystem 140 in administration work station 60. A billing subsystem 100 is responsible for credit card, debit card or checking account verification and all billing type functions.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the Internet by a “firewall” 90 which is a safety precaution, and important with respect to the present invention due to the sensitive and confidential nature of some of the material in the database.

In a preferred embodiment, the database subsystem 110 stores all pertinent information pertaining to user accounts, itineraries, administrator accounts, billing parameters, as well as general dynamic system information. All interactions with the database subsystem 110 are performed through a database API 110′ which may define the interface to a library of stored procedures 130. These are used to implement high-level database functions and to shield the details of the database implementation from the other subsystems. The database subsystem 110 is preferably implemented using database server 50.

The administration subsystem 140 provides an interface for operators and managers of the system to modify the database, print reports, view system data and log user comments and complaints. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to notify both planners and venues 16, 18. Users 16, 18 may be notified by phone, fax, email or pager, or other communications devices which can be contacted by the system 135. Some portable telephones and pagers include email addresses and so may be contacted by the email system; other users have only phone numbers. Other interfaces may be utilized as the application so demands.

A batch subsystem 125 may periodically send out grouped notifications. It will access the database subsystem 110 to determine what notifications are required, and uses the communication subsystem 120 to make those notifications. The billing subsystem 100 will be used to verify and bill credit cards and communicate through the billing API 100′ to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50 logs planner and provider setup and account creation information, stores itineraries and changes made to that information, maintains user account information, maintains account balances, produces and prints reports, hosts backup operations and performs statistical calculations for the entire system.

The database server 50 is preferably a dual processor computer microprocessor. Each connection to the database 150 and its associated work may be handled by a separate thread within the database server 50 process space. It is anticipated that a dual processor machine is sufficient for the type and amount of transactions that it will be performing, however if it proves insufficient, the database can be “striped” to two or more machines to distribute the server load.

The disk subsystem 190 of the database server may comprise a vulnerable and crucial server element. Due to the mission critical design of the subsystem, it is preferable to utilize a Level 5 RAID. RAID is an alternative to standard SCSI hard disk drives. A RAID system provides automatic recovery from hard drive failures. Level 5 RAID systems provide the best balance between cost and level of data protection. A Level 5 RAID system uses multiple hard disk drives, on which the stored data is recorded redundantly using a scheme by which the data on the disk can be reconstructed if one of the disk drive units in the RAID fails. In the event of failure, the failed drive can be removed from the RAID system while it is still operating, and a replacement drive can be installed. The RAID system will regenerate the data and return itself to full protection capability. The data sorted on the disk subsystem remains available for normal processing, that is from the time the drive failures to the time the RAID system is returned to full protection capability. Other levels of RAID which are less costly do not offer this type of data availability and could translate into costly system downtime.

Statistical calculations will be performed by the database server 50, along with other types of report generation. Specifically, IIS can log directly to an Open Database Connectivity ((ODBC) standard data source. This makes the availability of the data collected by the database server about client activity on the system more readily available and easier to process into logical reports. Preferably the database server system is configured with a dual P6 CPU, 128 MB ECC, having sufficient ECC RAM, a graphics adapter capable of showing 1024×768 pixels with a depth of 8 bits, a 15 inch monitor, a PCI Fast/Wide SCSI-2 I/O adapter, one PCI 100 base T Ethernet adapter, a keyboard and a mouse, a 3.5 inch floppy drive, a CD ROM Drive, a disk drive, a 2 GB PCI Fast/Wide SCSI-2 hard disk drive, two 9 GB PCI Fast/Wide SCSI hard drives (Level 1) or an 8 GB RAID Subsystem (Level 5), and a 24 GB DAT SCSI (2 MB per minute) tape back-up unit.

In one embodiment, there will be one operator workstation 60 used for administering the system. As the need for additional workstations arises, additional operator workstations can be added by adding additional computer systems, installing the administration software and connecting them to the LAN. Operator workstation machines preferably utilize a Windows operating environment manufactured by Microsoft Corporation.

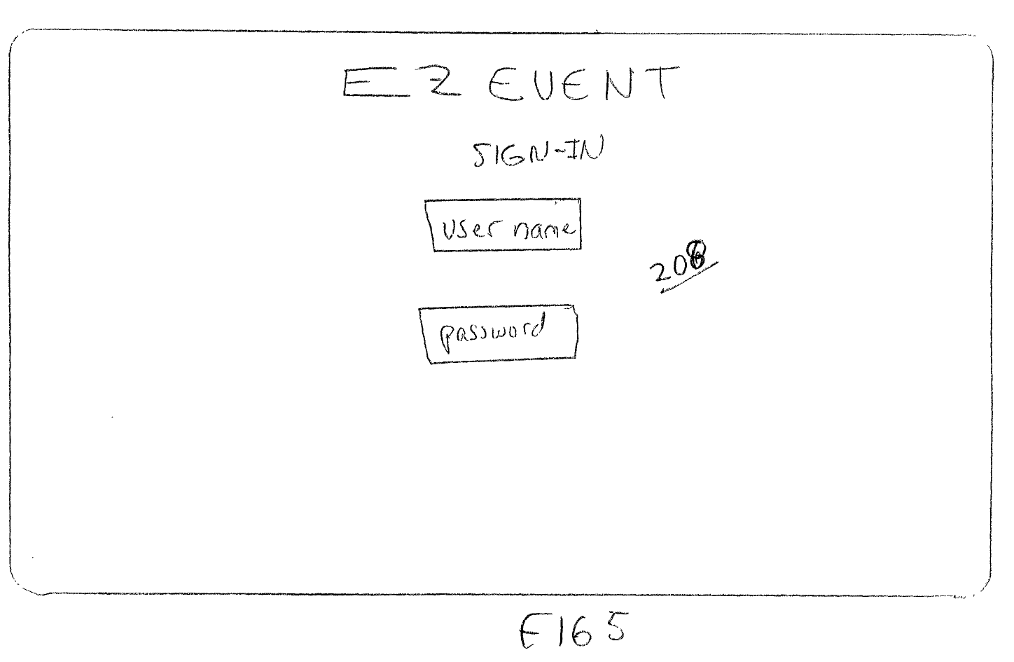

With the above background setting forth the operation environment of the present invention, referring now to FIGS. 4 to 13, the present invention is now more fully described. The invention is directed to a system having two interface areas to server 12, one for event planner 14 and one for a venue 16 in which an planner end users 16. Each user interface may have a separately accessible URL.

Referring now to FIG. 4, the present invention is directed to a system for placing requests for proposal to be responded to by a restaurant, caterer or other related entity which desires to participate in the system. These venues 18 can then respond to requests for proposal from individual planner 16 inquiries. The present invention is directed to a system by which prospective planners can contact and request events based upon date, price, location and a host of other desired factors and criteria.

While the above embodiment describes a single computer acting as a central processor, those skilled in the art will realize that the functionality can be distributed over a plurality of computers. The Figures illustrate a so-called front end of the system and are shown in the context of a commercial website under the commercial name and URL (universal resource locator) E-Z EVENT.com.

Referring now to FIGS. 4-14, in a preferred embodiment, the central processor 10 hosts a web site comprising a plurality of user screens and backend which are utilized by an event planner and event site. Referring to FIGS. 4, the client front end of the system is shown in detail. As shown in FIG. 4, a user screen 201 which is accessible via the web browser of the client comprises an introductory text 200 which will introduce the service to the end user. This page will preferably include FAQ (Frequently Asked Questions) 202 and a bulletin board 204. FIG. 4 illustrates the terms of service 206 to which the client must agree in order to access the service.

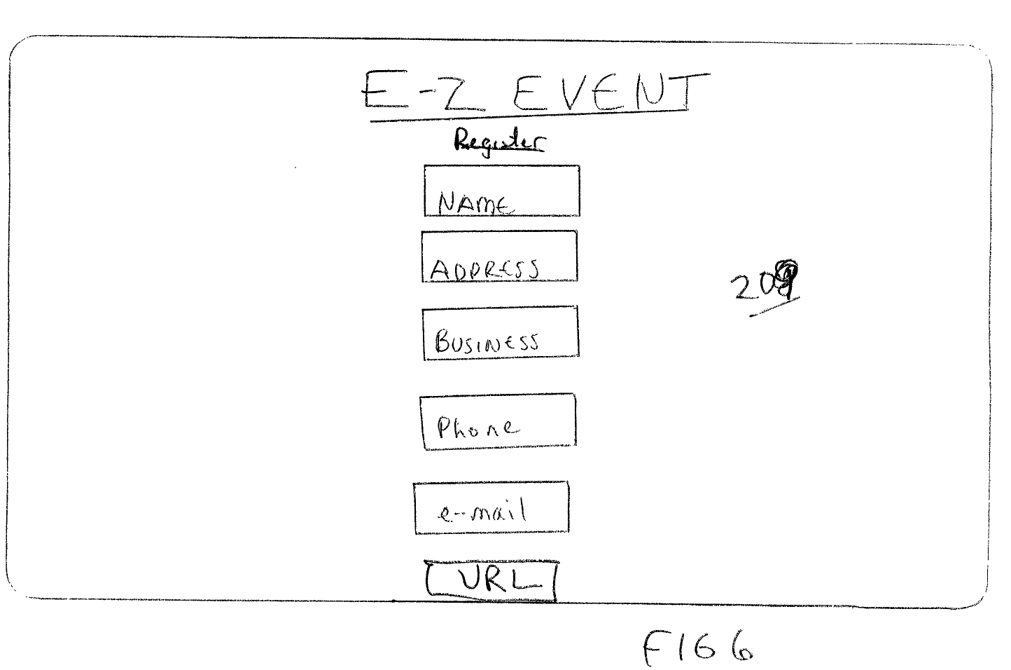

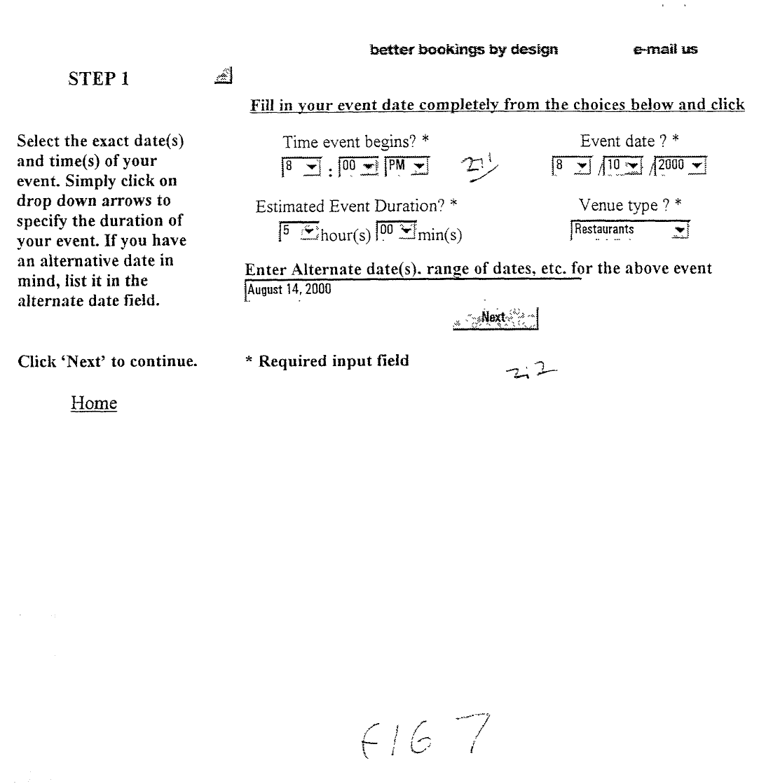

FIG. 5 comprises the input screen where the end user inputs a user name and password 208. If the client is a new user and has no user name and password, he is then taken to the screen shown in FIG. 6 which comprises a client intake form or screen 209. The intake screen 209 comprises a plurality of user data fields in which the client inputs individual demographic information about himself and his business including, name, address, URL, e-mail and type of organization and payment options.

After inputting the requisite client information, as shown in FIG. 6, the planner is then provided with his user name and password 208 and may access further features of the system. The client is then introduced to a series of screens for formulating his fee proposal which will be discussed below.

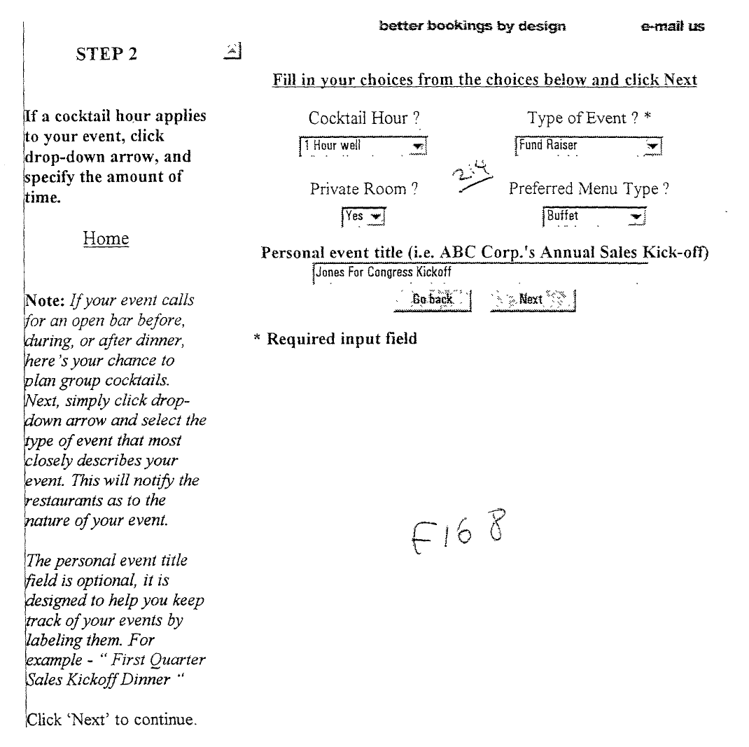

Referring now to the FIGS. 7-13, a more preferred embodiment of the present invention is shown in detail. As shown, the present invention is specifically designed to be utilized by event planners. Such an event planner can enter the system and place an RFP.

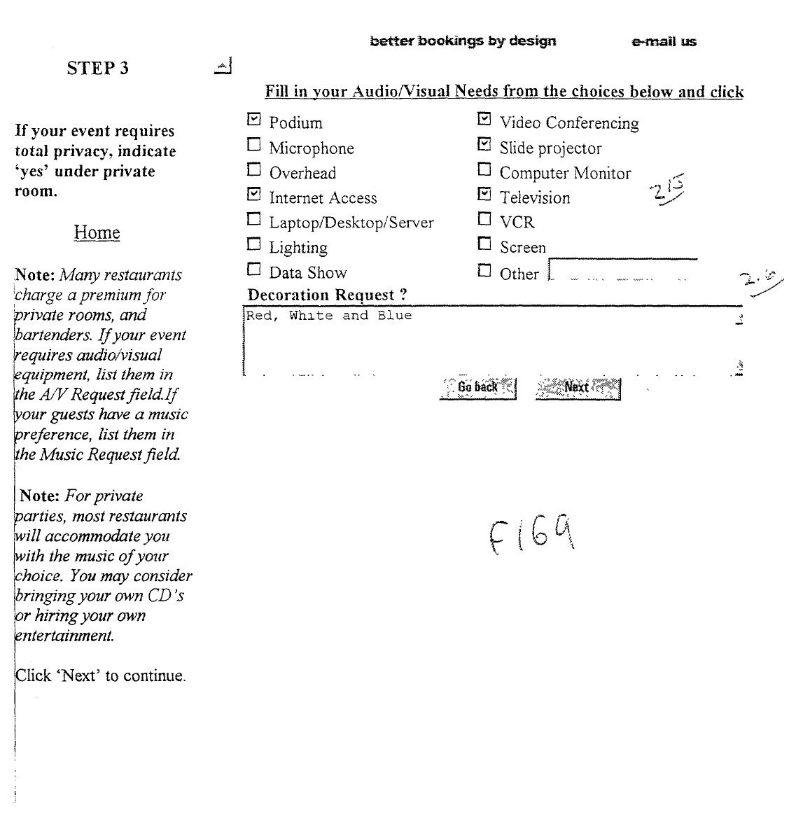

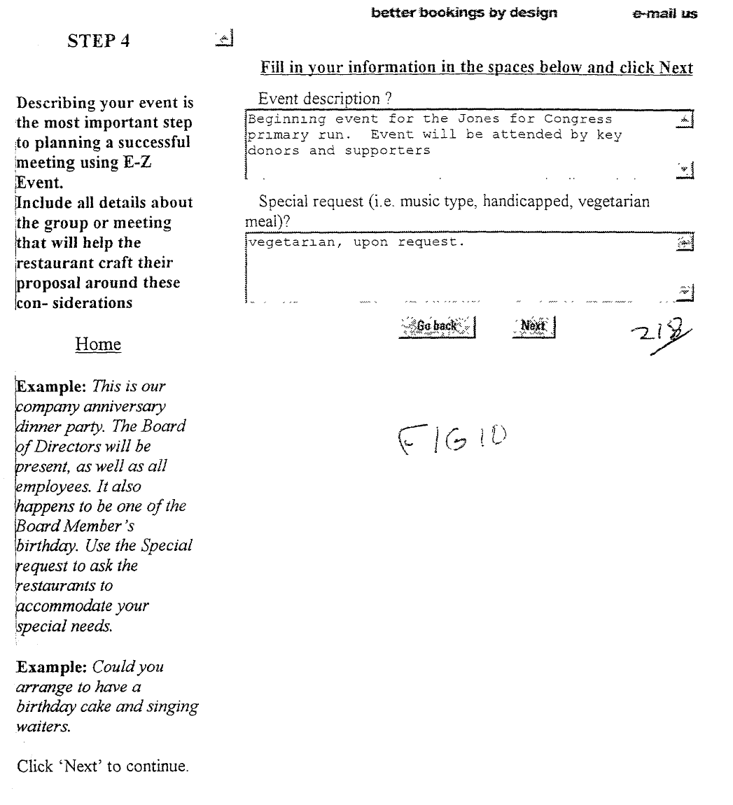

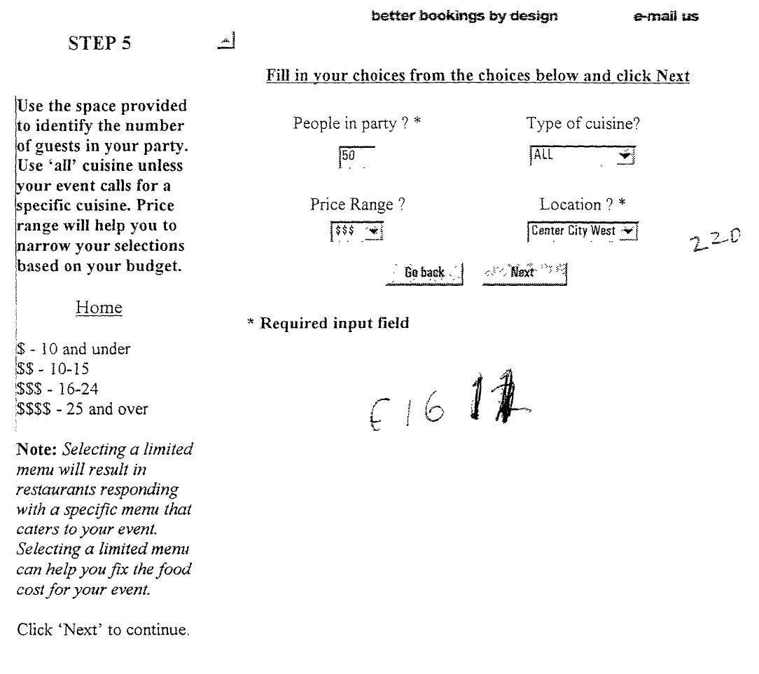

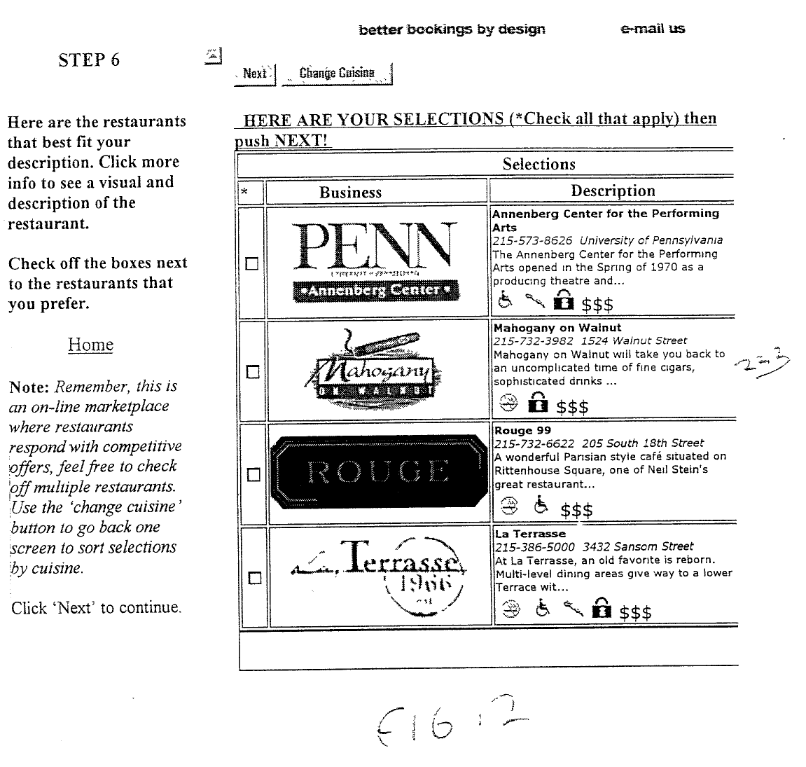

As shown in FIG. 7, the first screen requests the time of the event and its duration and date 211. The end user planner is given the ability to add additional information about alternative dates, range of dates, etc. 212. In the next screen of FIG. 8, the planner is permitted to set forth information about the cocktail hour, the type of the event, whether he wants a private room and the preferred menu 214. The planner may give the event a title. In the next screen of FIG. 9, the end user can put in various audiovisual needs 215, and any aspect of decoration 216. FIG. 10 illustrates a screen for placing information about the event 218 and making special requests. As shown in FIG. 11, the screen, the end user puts in the number of people at the occasion, the type of cuisine to be served, a price range and a location 220.

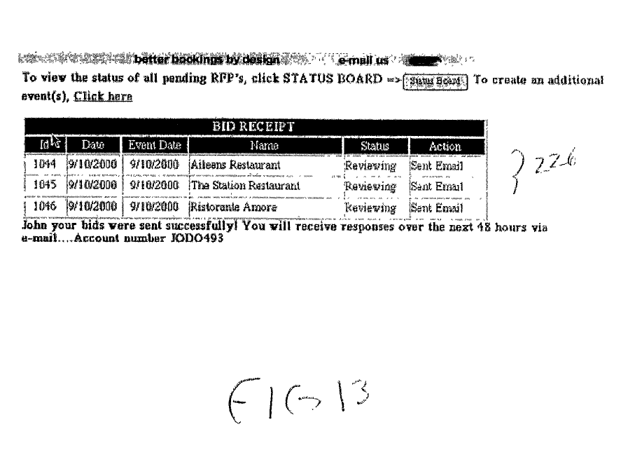

The end user is then provided with information about the various restaurants which meet the requested criteria as shown in FIG. 12. The user will be given information, including a brief description of the restaurant, smoking policy, handicap access and price range 222. When the venue gets this information, it will then put together a bid or proposal.

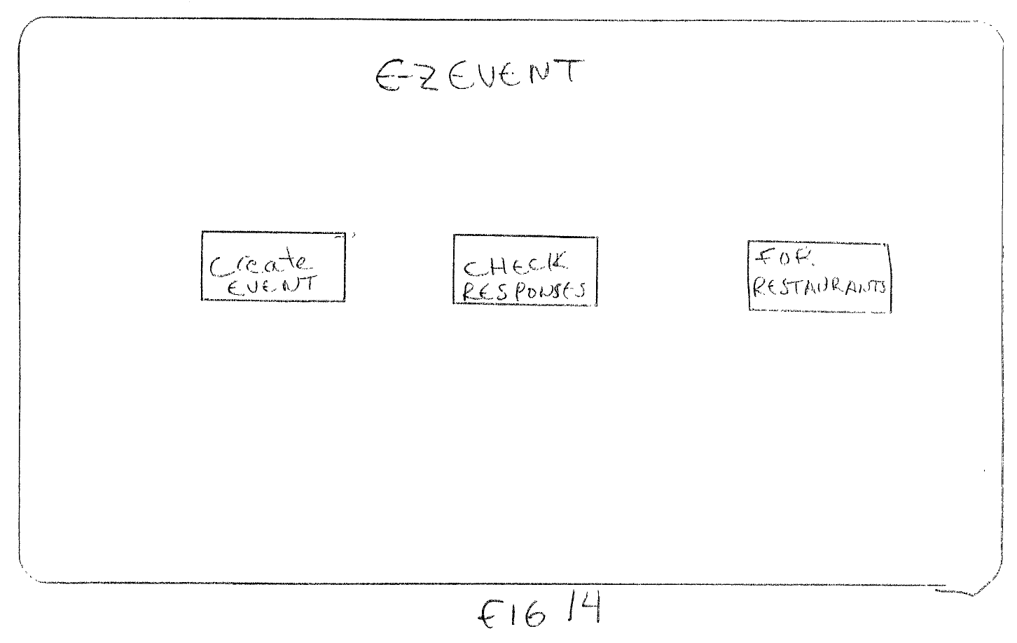

As shown in FIG. 13, the planner is then provided with an e-mail which informs the end user of the bid or proposal. Subsequently, the bid or proposal is sent out to the selected restaurants which meet the criteria set forth by the planner. The restaurants can then put forth a bid which will set forth an entire price range for the planner. This is placed in an e-mail box which is accessible by the planner 226. This screen identifies the bid by mark and provides the planner with a status update. FIG. 14 illustrates an alternative entrance screen.

If the planner approves one of the bids, the planner will then place a deposit on the bid, a percentage of which will be paid to the service.

The present system incorporates an administrative back end which controls the system and which can be used to make other administrative changes to the system. Referring to FIG. 3, an administrative server is provided. The administrative server provides standard administrative features such as traffic monitoring, providing a log of those who access the site, the identity of event site and clients who register with the site, and other database parameters.

It is to be appreciated and emphasized that the system set forth herein is independent of computer operating systems and will work equally well in a wireless environment such as those embodied by PDA devices and tom pilots. In a more preferred embodiment of the present invention, the present invention is directed to an internet or virtual private network which can be utilized to book an event. In such an embodiment, the invention will reside with the appropriate official of a major business or organization such as a pharmaceutical company. Individuals within the organization which desire events can access a program.

One of the unique features of this particular application is that a number of reporting features can be created for the organization. For example, in the case of a pharmaceutical company, the names of particular sales representatives can have their own files. Detailed reporting of expenditures, events, doctors, and the results can be tracked. In this way, the organization can determine which methods of entertainment yield the best results. This system can further track the comments on speakers which appear at events, which are common in pharmaceutical-related entertainment.

The present invention is described with reference to the above-discussed preferred embodiments. It is to be recognized that other embodiments fulfill the spirit and scope of the present invention and that the true nature and scope of the present invention is to be determined with reference to the claims attached hereto.

1. An apparatus for managing communications between an event site and prospective planner comprising:
a control unit for establishing a request generated by a planner relating to a desire for event services;
means for assisting a client in formulating a request for proposal to be distributed to event sites throughout the system;
means for distributing the request for proposal to said event sites; and
means for receiving bids from event sites who receive the request for proposal.

2. An event site matching apparatus for managing communications between an event site and a prospective planner seeking to schedule an event:
a control unit for receiving a request from a prospective planner relating to desired event services;
means for assisting the prospective client in formulating a request for proposal to be formatted and distributed throughout a network;
means for distributing the request for proposal throughout a network to a plurality of event sites;
means for event sites to respond to the request for proposal with a bid; and
means for the prospective planner to request additional information from event site.
